(19) United States
(12) Patent Application Publication
(10) Pub. No.: US 2021/0208695 A1
(43) Pub. Date: Jul. 8, 2021

(54) POINTING DEVICE

(71) Applicant: LG ELECTRONICS INC., Seoul (KR)

(72) Inventors: Joonwon BYUN, Seoul (KR); Jongpil KIM, Seoul (KR); Jinbum KIM, Seoul (KR); Gunshik SHIN, Seoul (KR); Jeongho WOO, Seoul (KR); Sungbum JOO, Seoul (KR)

(73) Assignee: LG ELECTRONICS INC., Seoul (KR)

(21) Appl. No.: 17/056,620

(22) PCT Filed: Oct. 11, 2018
(86) PCT No.: PCT/KR2018/011940

§ 371 Date: Nov. 18, 2020

(30) Foreign Application Priority Data
Jun. 1, 2018 (KR) 10-2018-0063795

(51) Int. Cl. G06F 3/03; G06F 3/038

(52) U.S. Cl. CPC G06F 3/0304; G06F 3/0383

(57) ABSTRACT

Provided is a pointing device in the form of a direct signal generation pen, for recognizing handwriting on any outer surface in order to solve an error of handwriting trajectory generated by the rotation of a pen, the pointing device comprising: an optical module for irradiating light on the outer surface and receiving reflected light so as to sense the frequency of the reflected light; an inertial sensor for sensing the movement, rotation, and azimuth of the pointing device; and a calculation unit for setting a reference coordinate system having handwriting direction information on the basis of a sensing value of the optical module or the inertial sensor, and recognizing first handwriting information on the basis of the set reference coordinate system.

### TECHNICAL FIELD

The present disclosure relates to a pointing device including an optical module for tracking a coordinate, having the optical module and an inertial sensor.

### BACKGROUND ART

A pointing device refers to a device that generates an input signal such as a movement or a selection of a coordinate to a linked terminal device.

In particular, a pen-type pointing device includes an indirect signal generating pointing device that allows the terminal device to generate the input signal by directly touching a touch screen of the terminal device.

In principle, the indirect signal generating pointing device does not require a separate battery and performs an input by physically contacting the touch screen, so that there is little error between a movement trajectory intended by a user and a movement trajectory that is actually input.

However, because the indirect signal generating pointing device must directly contact the touch screen, a moving region is limited and the touch screen is covered.

A direct signal generating pointing device compensates for such disadvantages. As the direct signal generating pointing device performs the input by tracking a movement of the device itself, in principle there is no limit to a target surface. Therefore, writing may be performed on any surface, such as a notebook, a desk, or the like, not an electronic device.

Such direct signal generating pointing device recognizes the movement trajectory through an optical module.

In particular, among the direct signal generating pointing devices, there is a pointing device that is implemented in a shape of a pen and generates the input signal by being gripped by the user in a manner of holding the pen. This is referred to as a pen-type direct signal generating pointing device. The pen-type direct signal generating pointing device mainly performs a function optimized for the writing.

However, in such a pen-type direct signal generating pointing device, writing intended by the user is often not performed because of limitation in a sensing capability of the optical module that recognizes a writing trajectory. This is because, unlike a general pointing device, the pen-type direct signal generating pointing device is often separated from a writing surface, and an inclination of the device is often changed continuously because the writing is performed in a state in which the device is gripped in the hand.

### DISCLOSURE

### Technical Purpose

The present disclosure aims to solve the above-described problem, in which the writing input is not accurately performed in the conventional pen-type direct signal generating pointing device.

### Technical Solutions

According to one aspect of the present disclosure to achieve the above or other purposes, provided is a pointing device in a shape of a pen for recognizing writing on an arbitrary outside surface including an optical module for irradiating light on the outside surface, receiving the reflected light, and sensing a frequency of the reflected light, an inertial sensor for sensing a movement, a rotation, and an azimuth of the pointing device, and a calculator that sets a reference coordinate system having writing direction information based on a sensing value of the optical module or the inertial sensor, and recognizes first writing information based on the set reference coordinate system.

Further, according to another aspect of the present disclosure, provided is the pointing device, wherein the writing direction information is a direction of a writing trajectory sensed by the optical module or the inertial sensor.

Further, according to another aspect of the present disclosure, provided is the pointing device, wherein the writing direction information is determined based on an inclination on an absolute coordinate system of the pointing device.

Further, according to another aspect of the present disclosure, provided is the pointing device, wherein the calculator calculates an inclination degree of the pointing device with respect to a specific reference axis on the reference coordinate system, and corrects the first writing information to second writing information to correspond to the calculated inclination degree.

Further, according to another aspect of the present disclosure, provided is the pointing device, wherein the second writing information is obtained by moving the first writing information in a direction opposite to an inclined direction of the pointing device, wherein a movement degree varies based on the inclination degree of the pointing device.

Further, according to another aspect of the present disclosure, provided is the pointing device, wherein the calculator calculates a degree of rotation with a pen axis of the pointing device as a rotation axis, and resets the set reference coordinate system in response to the calculated degree of rotation.

Further, according to another aspect of the present disclosure, provided is the pointing device, wherein the reset reference coordinate system is obtained by rotating the set reference coordinate system by the degree of rotation in a direction opposite to a rotation direction of the set reference coordinate system.

Further, according to another aspect of the present disclosure, provided is the pointing device, wherein the optical module and the inertial sensor are arranged biased in a direction of a pen tip of the pointing device.

### Advantageous Effects

Effects of a mobile terminal device according to the present disclosure are as follows.

According to at least one of the embodiments of the present disclosure, writing recognition accuracy may be improved.

Further, according to at least one of the embodiments of the present disclosure, there is an advantage that a line drawing process performed before actual writing may be omitted.

Further scope of the applicability of the present disclosure will become apparent from a detailed description below. However, various changes and modifications within the spirit and scope of the present disclosure may be clearly understood by those skilled in the corresponding technical field, so that it is to be understood that the detailed description and specific embodiments such as preferred embodiments of the present disclosure are given by way of example only.

### DESCRIPTION OF DRAWINGS

FIG. 1 shows a pointing device associated with the present disclosure.

FIG. 2 shows a cross-section of an optical module for describing a principle of a pointing device associated with the present disclosure.

FIG. 3 shows a cross-section of an optical module for describing a principle of a pointing device associated with the present disclosure.

FIG. 4 shows an embodiment of a pointing device associated with the present disclosure.

FIG. 5 shows an error resulted from inclination of a pointing device by an optical module.

FIG. 6 shows a process of solving an error occurred in FIG. 5.

FIG. 7 shows an error resulted from rotation of a pen axis of a pointing device.

FIG. 8 shows a process of solving an error occurred in FIG. 7.

FIG. 9 is a flowchart describing a process of recognizing writing and generating an input signal associated with the present disclosure.

### BEST MODE

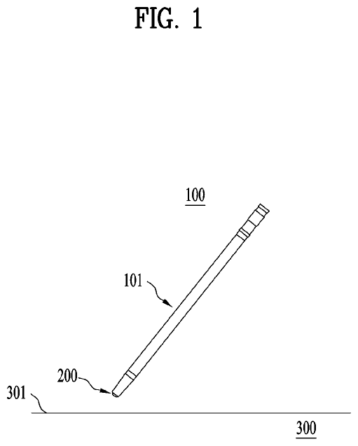

FIG. 1 shows a pointing device 100 associated with the present disclosure.

It is assumed that the pointing device 100 to be described later is the pen-type direct signal generating pointing device 100 described above. Features to be described later may be applied to all other types of pointing devices 100 within a range not contradictory.

The pointing device 100 generates an input signal by writing on an arbitrary writing surface 300. Such input signal contains movement information for top, bottom, left, and right components on the writing surface 300 of the pointing device 100. The input signal may be implemented as writing information or information performing a specific function for the corresponding pointing device 100 or an external terminal device connected to the pointing device 100.

There are no specific restrictions on a material or a shape of the writing surface 300. Such feature is distinguished from a usual pointing device that may only write on a touch screen.

For implementation of the pointing device 100 having such feature, the pointing device 100 emits light and includes an optical module 200 for receiving the emitted light. Specifically, the optical module 200 may track coordinates in which the pointing device 100 moves by recognizing a movement and a moving direction of the pointing device 100 using principles of refraction and diffraction of the light.

The pointing device 100 includes a body 101 for being gripped by a user and the optical module 200 mounted on the body 101. When necessary, a component, for example, a physical button, for generating an input signal in a method other than the writing may be additionally implemented.

The input signal recognized and generated through the optical module 200, a calculator, and the like may be transmitted to an external device through a wireless communication device. For example, when the input signal contains information on a movement to the right of the pointing device 100, the input signal may be transmitted to a mobile terminal device and cause a pointer to move to the right.

In this connection, because the optical module 200 should receive the light again after irradiating the light on the writing surface 300, it is preferable that the optical module 200 is disposed at an end of the pointing device 100.

The pointing device 100 may have a power supply for electrical operation of the components.

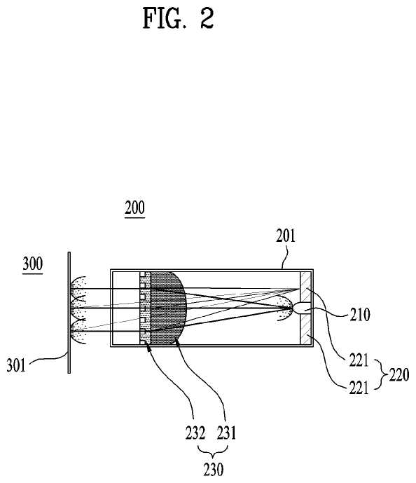

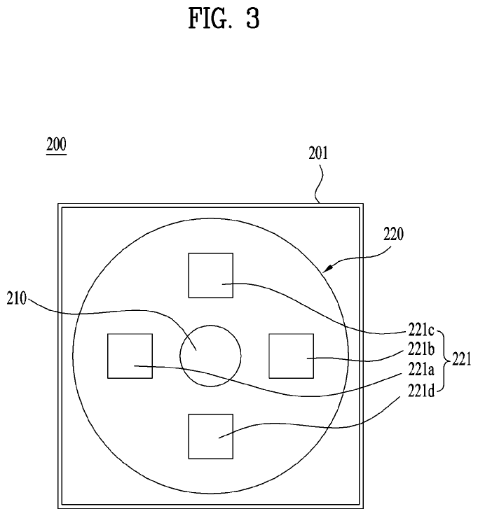

Each of FIGS. 2 and 3 shows each cross-section of the optical module 200 for describing each principle of the pointing device 100 associated with the present disclosure. FIG. 2 is a cross-section of the optical module 200 cut to contain an optical axis. FIG. 3 is a cross-section of the optical module 200 cut perpendicular to the optical axis.

A light emitter 210 of the optical module 200 that recognizes the writing using the diffraction of the light irradiates the light toward the writing surface. The light emitter 210 may include a vertical-cavity surface-emitting laser (hereinafter, a VCSEL). Because the light irradiated through the light emitter 210 has a spreading property, that is, a divergence property, it is efficient in terms of energy that the light emitter 210 is disposed at a center of a casing 201 of the optical module 200.

When the light irradiated through the light emitter 210 is reflected from an outside surface 301 and returns, a light receiver 220 receives the light. The received light may be analyzed and converted into the movement information of the pointing device 100.

A lens assembly 230 refracts and diffracts the emitted light, so that the light receiver 220 may receive light with appropriate information.

Regarding the refraction of the light, the lens assembly 230 makes the light emitted from the light emitter 210 and diverging to travel parallel, and refracts the light reflected from the target surface 301 to be focused to the light receiver 220.

Regarding the diffraction of the light, the lens assembly 230 diffracts the light reflected from the target surface 301 to reach the light receiver 220. The reflected light is diffracted, so that only appropriate information may be collected. In particular, the light receiver 220 may analyze only light of a 1st order or a −1st order from the diffracted light. This is because the diffracted light of the 1st order or the −1st order has a relatively high efficiency.

The light reaches a plurality of points of the light receiver 220. In particular, when the pointing device 100 moves, the movement of the pointing device 100 may be calculated based on a change in a wavelength of the light.

The pointing device generates a final input signal through processes of setting a reference coordinate system and correcting an error of a writing trajectory.

The setting of the reference coordinate system provides a reference that may be implemented in the linked terminal device and the like by converting the writing trajectory into a coordinate. For the setting of the reference coordinate system, a conventional pointing device requires a line drawing to set a reference of a writing direction before starting the writing. When the user draws the line in an intended writing direction, the intended writing direction of the user is recognized as the writing direction of the reference coordinate system and synchronized with a writing direction of the connected terminal device. Such conventional reference coordinate system setting process is inconvenient in that an additional process is required for the user.

Further, when a coordinate axis is changed during the writing, for example, when the user adjusts grip thereof on the pen during the writing and the pen rotates, there is a disadvantage that it is difficult to reflect the changed coordinate axis.

In addition, there is a difference between a writing trajectory intended by the user and a writing trajectory recognized by the pointing device because of inclination of the pointing device during the writing. However, the conventional pointing device does not reflect the difference, which causes an error.

The pointing device 100 of the present disclosure solves the disadvantages using the equipped optical module and inertial sensor.

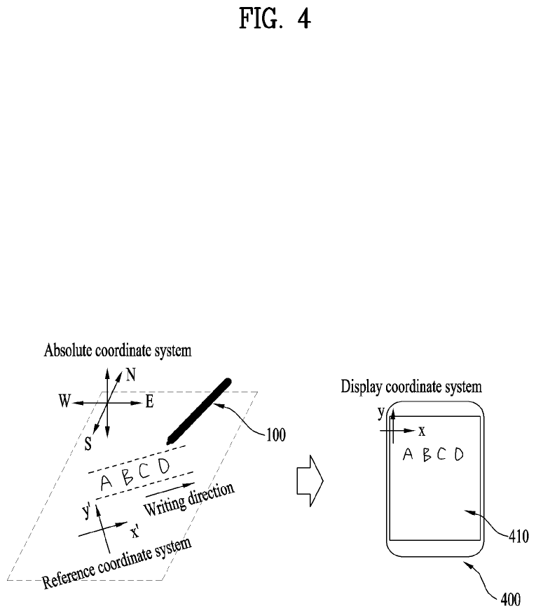

FIG. 4 shows an embodiment of the pointing device 100 associated with the present disclosure.

The inertial sensor senses the movement, a rotation, and an azimuth of the pointing device 100. To this end, the inertial sensor may be implemented as an inertial sensor in a 9-axis sensing scheme. Unlike 6-axis sensing, 9-axis sensing enables geomagnetic sensing, so that setting of an absolute coordinate system based on a geomagnetic axis is possible. In other words, the 9-axis sensing inertial sensor may identify not only a movement degree and a rotation degree of the pointing device 100, but also a current angle based on the geomagnetic axis.

When it is recognized that the writing has begun by sensing of the optical module or the inertial sensor, the calculator may set the reference coordinate system and the writing direction based on the sensing of the optical module or the inertial sensor.

The reference coordinate system and the writing direction may be set based on a sensing value of the optical module or the inertial sensor.

An x′-y′ plane of the reference coordinate system may be a plane containing a writing trajectory recognized by the inertial sensor. On the absolute coordinate system, the calculator may set the reference coordinate system by setting the plane containing the writing trajectory as the x′-y′ plane of the reference coordinate system and setting an axis perpendicular to the set x′-y′ plane is set as a z′ axis.

The following describes several methods to set the writing direction. In FIG. 4, an x′ axis of the x′-y′ plane is set as the writing direction, but this is for convenience only. In addition, any axis in the x′-y′ plane may be defined as the writing direction.

First, the writing direction is expected based on a direction of a character recognized through OCR and the like. In other words, the calculator may set a horizontal axis of the character in a state in which the written character is rightly placed as the writing direction.

Second, a direction of the writing trajectory recognized by the optical module or the inertial sensor may be set as the writing direction. In other words, the direction of the writing trajectory formed by writing a plurality of letters may be set as the writing direction.

Third, the writing direction may be determined based on an inclination of the pointing device 100 on the absolute coordinate system.

An approximate writing direction may be predicted from a direction in which the user is gripping the pointing device 100. In other words, in the pen-type pointing device 100, an inclination of the pen and the writing direction are mostly related to each other. When the x′ axis of x′-y′-z′ axes of the reference coordinate system corresponds to the writing direction, and when is assumed that a pen axis of pen of a right-handed user has a (1, 2, 3) vector value in most of cases, the calculator may establish the x′-y′-z′ axes of the reference coordinate system in which a direction of the pen axis of the pen as sensed by the inertial sensor corresponds to the (1, 2, 3) vector.

When the reference coordinate system and the writing direction are set, the calculator may calculate the writing trajectory of the pointing device 100 recognized by the optical module or the inertial sensor as first writing information. The calculated first writing information may be an input signal to be input to a linked terminal device 400.

That is, the reference coordinate system and writing direction information are synchronized with a display coordinate system (x-axis, y-axis, z-axis) of a display 410 of the linked terminal device 400, so that the first writing information may be input to the terminal device based on the synchronization.

In this connection, the first writing information may be directly generated as the input signal and transmitted to the external terminal device 400, However, because the first writing information has an error in the writing trajectory caused by a cause to be described later, the calculator may generate the input signal by reflecting such error and correcting the first writing information to second writing information or by resetting the reference coordinate system.

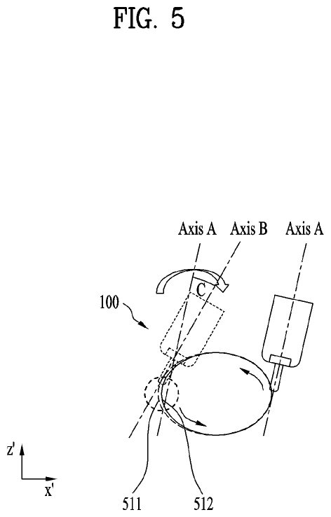

FIG. 5 shows an error resulted from inclination of the pointing device 100 by an optical module.

An inclination degree of the pointing device 100 may be changed during the writing.

As the inclination degree of the pointing device 100 changes, the writing trajectory intended by the user, that is, a user trajectory 511, and an expected writing trajectory recognized by the optical module 200 and calculated by the calculator, that is, before-correction recognized trajectory 512 have an error.

For example, when the pen-type pointing device 100 is inclined to the right with respect to an axis A and is located on an axis B as shown in FIG. 5, the pre-correction recognized trajectory 512 recognized by the optical module may be biased to the right more than the user trajectory 511.

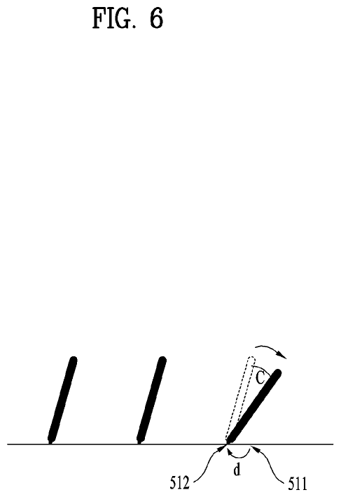

FIG. 6 shows a process of solving the error occurred in FIG. 5.

The calculator may correct the first writing information to the second writing information taking into account the error of the first writing information.

Referring to FIG. 6, as the inclination degree of the pointing device 100 increases, a deviation between the user trajectory 511 and the before-correction recognized trajectory 512 recognized by the optical module increases. Therefore, the calculator corrects the first writing information to the second writing information taking into account an inclination degree with respect to a reference axis.

In particular, when the pointing device 100 is in the shape of the pen, because the before-correction recognized trajectory 512 moves in a direction inclined with respect to the reference axis, the first writing information may be corrected to the second writing information by moving the recognized trajectory 512 in a direction opposite to the inclined direction.

A correction value d may be based on an inclination degree C. with respect to the reference axis A. In other words, as the inclination degree C. increases, the correction value d may increase.

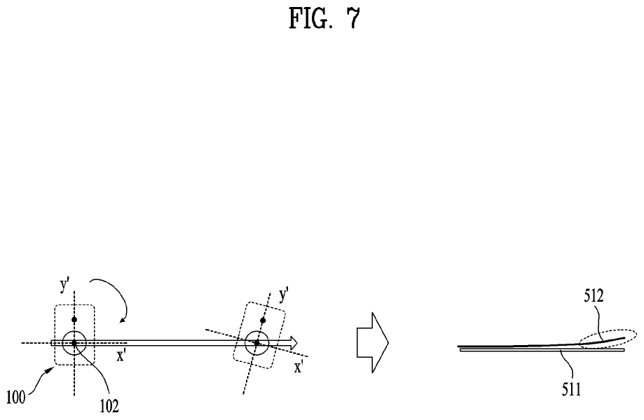

FIG. 7 shows an error resulted from rotation of a pen axis 102 of the pointing device 100.

The set reference coordinate system is fixed in principle, but changes when the pen axis 102 rotates.

When the reference coordinate system is changed, the user trajectory 511, which is the writing trajectory intended by the user, and the before-correction recognized trajectory 512, which is the writing trajectory recognized by the optical module, change.

For example, when a clockwise rotation with the pen axis 102 (assuming the same as the z′ axis in the present embodiment) of the pointing device 100 as a rotation axis occurs in the middle of drawing the line in the right direction, the before-correction recognized trajectory 512 is bent upward, resulting in a writing trajectory that goes upward in the right direction as a whole.

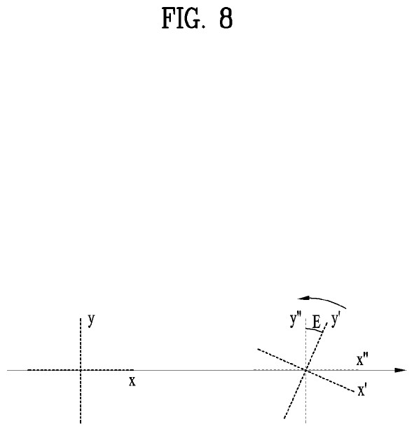

FIG. 8 shows a process of solving an error occurred in FIG. 7.

When the pointing device 100 rotates by E around the pen shaft 102, which is the rotation axis, the reference coordinate system (x′-y′) is rotated again by E in an opposite direction of the rotation and is reset as a x″-y″ reference coordinate system to recognize the writing.

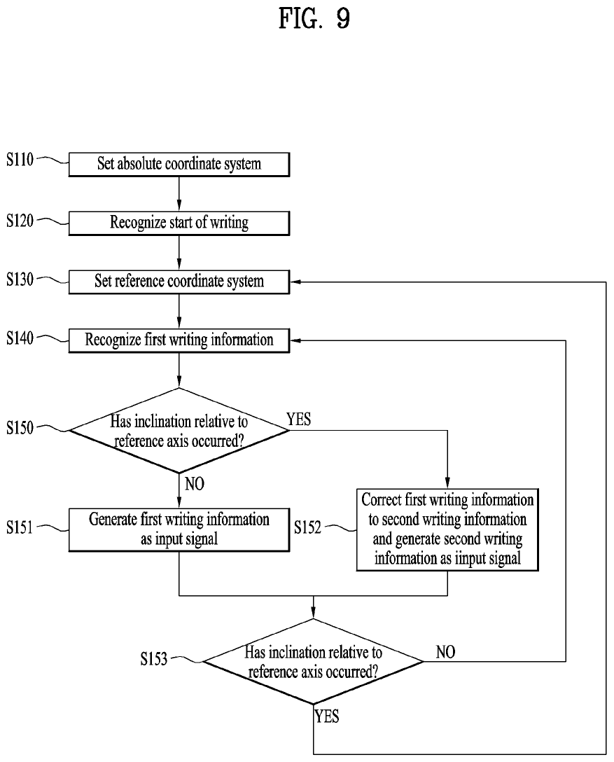

FIG. 9 is a flowchart describing a process of recognizing writing and generating an input signal associated with the present disclosure.

The inertial sensor 110 of the pointing device 100 sets the absolute coordinate system (S110). When the start of the writing by the user is recognized by the pointing device 100 (S120), the reference coordinate system is set based on the information recognized by the inertial sensor 110 (S130).

Based on the set reference coordinate system, the optical module 200 and the inertial sensor 110 recognize the writing trajectory, and the calculator calculates the first writing information (S140).

The inertial sensor 110 recognizes the central axis B of the pointing device 100, and the calculator calculates the inclination degree C. of the reference axis A of the reference coordinate system and the central axis B of the pointing device 100, and determines the correction amount d based on the calculated degree C. The calculator calculates the second writing information by reflecting the determined correction amount d to the first writing information. In other words, the calculator calculates the inclination relative to the reference axis A (S150) to determine the first writing information as it is as the input signal when the inclination is not occurred (S151) and to correct the first writing information and determine the second writing information as the input signal when the inclination has occurred (S152).

Afterwards, the input writing is repeatedly recognized and calculated. The inertial sensor recognizes the rotation with respect to the pen axis of the pointing device 100 (S160) to reset the reference coordinate system based on an amount of rotation when the rotation occurs (S161) and to continuously recognize the writing without resetting the reference coordinate system when the rotation has not occurred (S162).

An accuracy of the writing recognition resulted from the provision of the inertial sensor 110 may be increased even in a following situation.

An inter-stroke movement during the writing is determined by whether the pointing device is separated from the writing surface. The pointing device may recognize that the inter-stroke movement has occurred when an intensity of the light sensed by the optical module is equal to or less than a threshold value. Conventionally, because the inter-stroke movement is identified only with the optical module, there was an accuracy problem. However, when the inertial sensor is provided as in the present disclosure, because a movement in a z′-axis direction of the reference coordinate system may be recognized, the occurrence of the inter-stroke movement may be accurately identified.

During the inter-stroke movement, although no writing input occurs, the movement of the pointing device must be accurately recognized to determine a starting point of a next stroke.

To this end, the movement of the pointing device during the inter-stroke movement may be complexly identified using the optical module and the inertial sensor. The inertial sensor may solve a problem of not being able to accurately determine a degree of the movement of the pointing device because of decrease in the intensity of the light of the optical module during the inter-stroke movement.

Conversely, the inertial sensor may compensate for a situation that may be recognized by the optical module as the inter-stroke movement even though it is not the inter-stroke movement. When the writing is performed again at the same point after the pointing device 100 is separated from the writing surface for a short time, and when the sensing is performed only with the optical module, this situation may be recognized as the inter-stroke movement because of inaccuracy of an amount of movement. However, even in this case, the inertial sensor may recognize a movement in the z′-axis direction and a degree of movement on the x′-y′ plane in the moved state, and recognize this situation as a restart at the same point when the degree of movement is within a certain range.

It is obvious to a person skilled in the art that the present disclosure may be embodied in other specific forms without departing from the spirit and essential characteristics of the present disclosure.

The detailed description described above should not be construed as restrictive in all respects and should be considered as illustrative. The scope of the present disclosure should be determined by reasonable interpretation of the appended claims, and all changes within the scope of the present disclosure are included in the scope of the present disclosure.

What is claimed is:

1. A pointing device in a shape of a pen for recognizing writing on an arbitrary outside surface, the pointing device comprising:
an optical module for irradiating light on the outside surface, receiving the reflected light, and sensing a frequency of the reflected light;
an inertial sensor for sensing a movement, a rotation, and an azimuth of the pointing device; and
a calculator configured to:
set a reference coordinate system having writing direction information based on a sensing value of the optical module or the inertial sensor; and
recognize first writing information based on the set reference coordinate system.

2. The pointing device of claim 1, wherein the writing direction information is a direction of a writing trajectory sensed by the optical module or the inertial sensor.

3. The pointing device of claim 1, wherein the writing direction information is determined based on an inclination on an absolute coordinate system of the pointing device.

4. The pointing device of claim 1, wherein the calculator is configured to:
calculate an inclination degree of the pointing device with respect to a specific reference axis on the reference coordinate system; and
correct the first writing information to second writing information to correspond to the calculated inclination degree.

5. The pointing device of claim 4, wherein the second writing information is obtained by moving the first writing information in a direction opposite to an inclined direction of the pointing device,
wherein a movement degree varies based on the inclination degree of the pointing device.

6. The pointing device of claim 1, wherein the calculator is configured to:
calculate a degree of rotation with a pen axis of the pointing device as a rotation axis; and
reset the set reference coordinate system in response to the calculated degree of rotation.

7. The pointing device of claim 6, wherein the reset reference coordinate system is obtained by rotating the set reference coordinate system by the degree of rotation in a direction opposite to a rotation direction of the set reference coordinate system.

8. The pointing device of claim 1, wherein the optical module and the inertial sensor are arranged biased in a direction of a pen tip of the pointing device.
